(19) United States
(12) Patent Application Publication
(10) Pub. No.: US 2007/0205170 A1
(43) Pub. Date: Sep. 6, 2007

(54) Desk caddy

(76) Inventors: Shannon Gainer, Hillsdale, MI (US); Kevin Gainer, Hillsdale, MI (US)

Correspondence Address: YOUNG & BASILE, P.C., 3001 WEST BIG BEAVER ROAD, SUITE 624, TROY, MI, 48084, US

(21) Appl. No.: 11/365,171

(22) Filed: Mar. 1, 2006

(51) Int. Cl. A47G 29/087; B42F 17/00

(52) U.S. Cl. 211/119.005; 211/10

(57) ABSTRACT

A desk caddy intended for grade school children sitting at a desk having a storage bin. The caddy includes a box with integral front, back and opposite side walls and one or two internal dividers. One of the dividers, along with the front back and a side wall defines a water bottle compartment having raised ribs in the floor so that the bottle sits up off of the floor of the compartment. At least one hanger hook is integrated with the back wall so that the box may be hung on the edge of the storage bin. Alternatively, means are provided to slide the caddy onto the edge of a desk top. The unit is preferably made of injection molded plastic.

### FIELD OF THE INVENTION

This invention relates to utility boxes and more particularly to a molded plastic desk caddy suitable for use in combination with a student desk to hold a water bottle and various other paraphernalia.

### BACKGROUND OF THE INVENTION

It is common for students to “set up shop” at their desks not only with the usual pens, pencils, bookmarks, rulers and erasers, but also with a water bottle. Various attempts have been made to construct organizer boxes for pens, pencils, bookmarks erasers, and so forth. Similar attempts have been made to create holders for water bottles, but not with the needs of a student in mind; i.e.; most devices are sports related. To our knowledge, no one has designed or constructed a device which meets the objectives of holding student paraphernalia and a water bottle and does so in an aesthetically pleasing, as well as useful and economical fashion.

### SUMMARY OF THE INVENTION

In accordance with our invention, we provide a desk caddy which can be attached to conventional student desk and is capable of holding not only the ordinary paraphernalia of school students, but also a water bottle. In accordance with that objective, our desk caddy comprises integral front, back and opposite side walls and a floor extending between the front, back and side walls to define a generally rectangular box. Within the box we utilize at least one and preferably two dividers which extend between the front and back walls parallel to and spaced from the side walls to define two or three compartments, one of which is sized and shaped to accommodate a water bottle. In addition, we locate a raised pattern such as a plurality of parallel spaced vertical ribs in the bottom of the water bottle compartment such that the water bottle sits on the pattern and is raised above the compartment floor. The pattern may take any of many forms.

In the preferred form of our invention we incorporate a structure which can be used to attach the desk caddy to a desk. In one form, the attachment structure comprises a hanger which is integral with the top edge of the back wall and extends downwardly from the top edge in parallel, spaced relationship with the back wall. With this structure, the caddy may be hung on the side of a storage bin which is underneath the desk top. In this embodiment, the back wall is bumped out toward the bottom portion so that the desk caddy, when hooked over the top edge of a desk storage bin, sits more or less vertically upright rather than tilted.

In another form, the attachment structure allows the caddy to be attached directly to the edge of the desk top itself.

In the illustrated embodiments, we incorporate an aesthetically pleasing and utilitarian slope to the front wall so that at least one of the compartments is lower than the compartment holding the water bottle, thus facilitating access to smaller implements such as erasers and bookmarks. The entire box is preferably integrally made of injection molded plastic so as to be both useful and economical to manufacture.

### BRIEF DESCRIPTION OF THE DRAWINGS

FIG. 1 is a perspective view of a first illustrative embodiment of the invention attached to a conventional student desk;

FIG. 2 is a perspective view of the embodiment of FIG. 1 showing interior details;

FIG. 3 is a sectional view of the device of FIG. 2 along with section line 3-3;

FIG. 4 is a side view of the device of FIG. 1 showing how it is attached to the storage bin and the student desk; and

FIG. 5 is a side view of a second illustrative embodiment of the invention.

### DETAILED DESCRIPTION OF THE ILLUSTRATIVE EMBODIMENTS

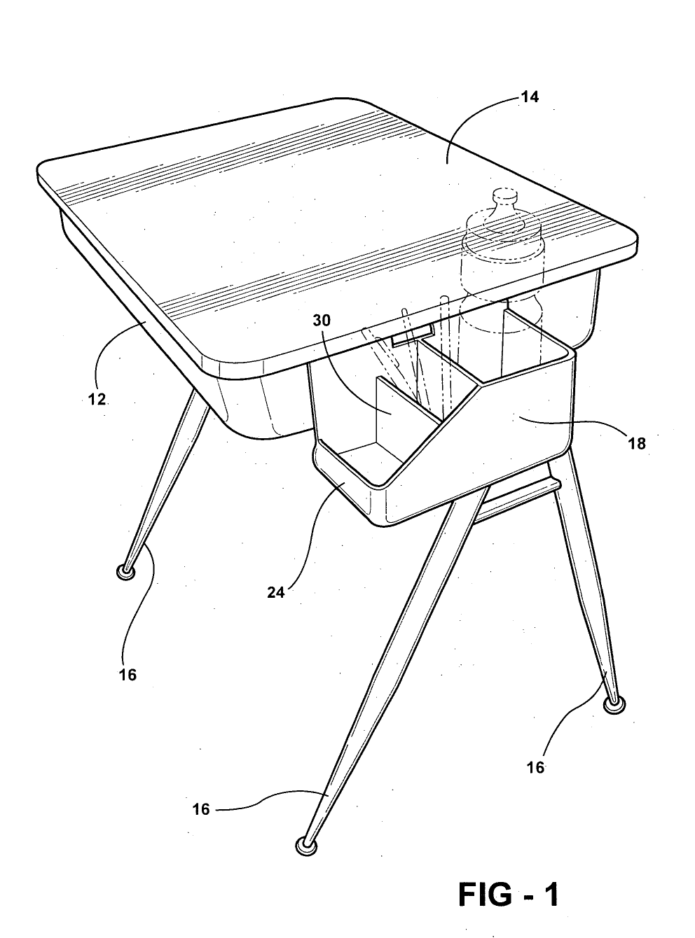

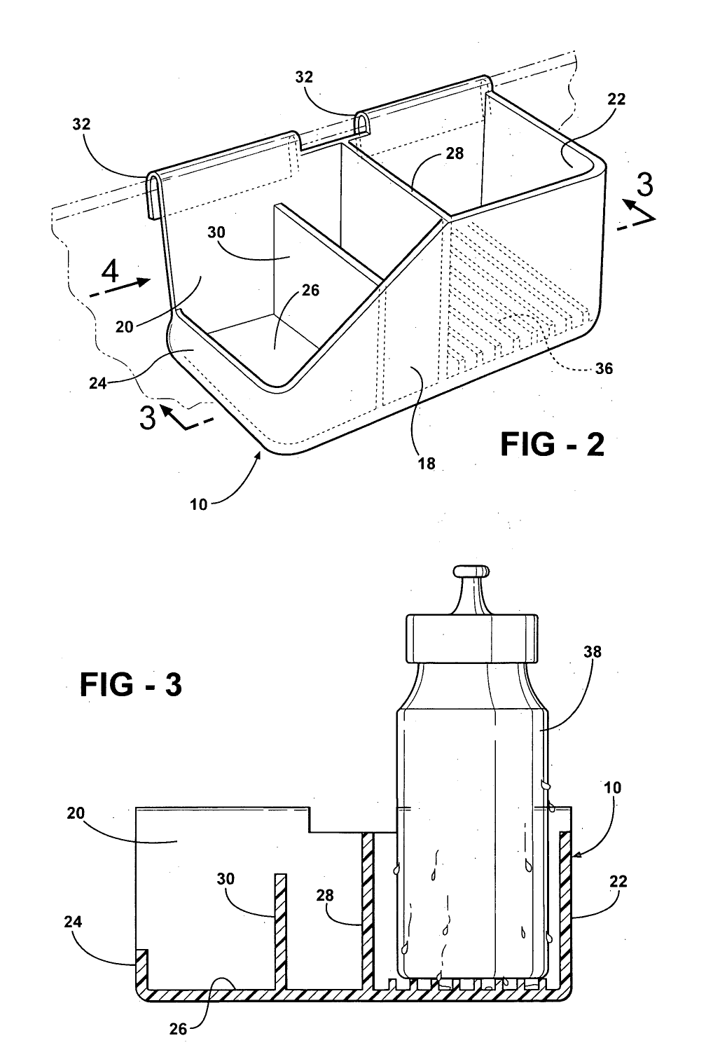

Referring to the drawing there is shown a molded plastic desk caddy 10 attached to the side of a storage bin 12 which underlies the hinged top 14 of a conventional student desk having metal legs 16. The desk caddy 10 is of integral molded plastic construction and comprises a front wall 18, a rear wall 20, opposite parallel side walls 22 and 24 extending between the front and back walls 18, 20, and a floor 26. In addition, spaced parallel dividers 28 and 30 run fore and aft between the front wall 18 and the rear wall 20 and are integral therewith. The left portion of the front wall 18 as shown in FIG. 2 is sloped and the divider 30 is shorter than the divider 28. Similarly, side wall 24 is shorter than sidewall 22 so as to facilitate access to the contents of the storage compartment defined by the space between the side wall 24 and the divider 30. That storage compartment lies closest to the student when the desk caddy 10 is mounted on the right side of a desk as shown in FIGS. 1, 2 and 4.

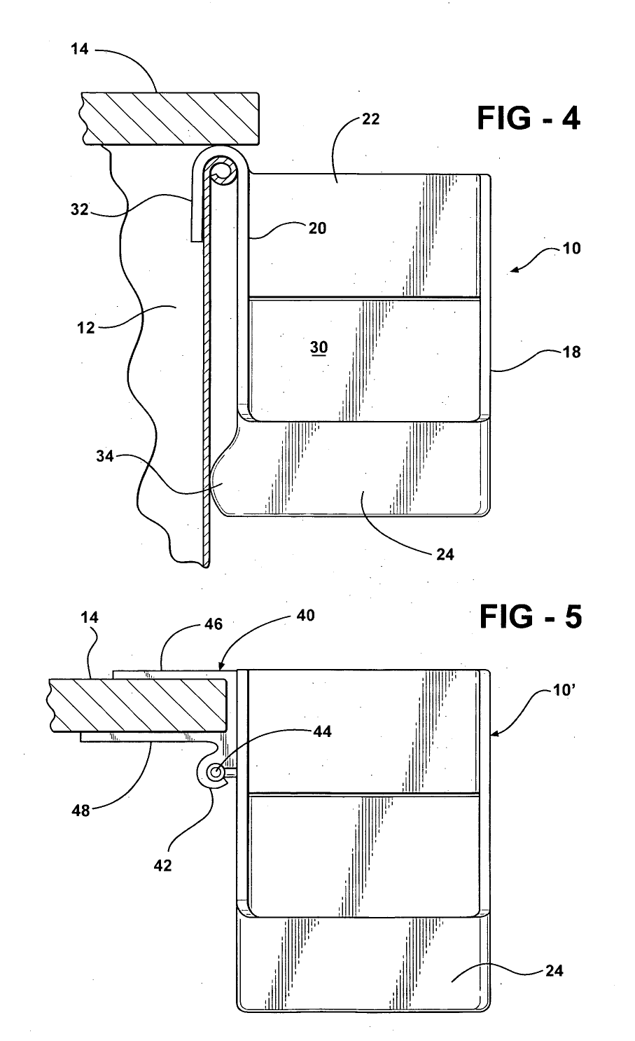

A pair of hangers or hooks 32 are formed integral with and extending downwardly from the top of the rear wall 20 in spaced relationship with the main portion of the rear wall 20 to permit the caddy 10 to be hung over the top edge of the metal (or plastic) storage bin 12 which is part of the conventional student desk as best shown in FIG. 4. The use of two spaced hooks 32 is merely illustrative as a single continuous hook as well as three or more separate parallel hooks may also be used. The use of multiple smaller hooks reduces the amount of plastic needed to manufacture the caddy 10.

As shown in FIG. 4 the lower rear wall portion 34 is bumped out to accommodate the space between the rear wall 20 and the side of the storage bin 12 so that the caddy 10 hangs essentially upright rather than tilted or angled. The bumped out lower back portion 34 can be achieved integrally by thickening the rear back wall portion or by adding a strip of plastic or other material to the caddy 10 after it has been injection molded.

The tallest compartment; i.e., the compartment defined by the side wall 22 and the divider 28 is sized to accommodate a water bottle 38 and is further provided with spaced parallel ribs 36 in the floor 26 of that compartment so as to raise the bottom of the bottle 38 up off of the floor. This provides an area for the collection of water which may condense on the side of the bottle 38 if the contents thereof are chilled and used in a room with high humidity. The parallel pattern of ribs 36 is merely illustrative of various raised patterns which can be used.

In use, the top 14 of the student desk is raised by means of hinges (not shown) and the caddy 10 is hung on the side of the storage bin 12 as shown. The desktop 14 is then lowered and the caddy 10 remains in place as long as the student occupies the desk. It is a simple matter for the student to disengage the caddy 10 from the desk and place it in a backpack or locker or other storage facility when the school day is over.

Referring to FIG. 5, a second embodiment includes a caddy 10′ substantially identical to the caddy 10 of FIGS. 1-4 but with an attachment structure 40 adapted to mount caddy 10′ on the edge of the desk top 14. Structure 40 includes parallel top and bottom flanges 46 and 48 attached to a beaded projection 44 on the back of the caddy 10′ by way of a hinge 42. The flanges 46 and 48 are spaced apart by the thickness of the desk top 14 and simply slide onto the desktop 14 as shown. The hinge 42 and 44 allows the structure 40 to fold down or be removed entirely.

As indicated in several places above, the embodiment of the invention described herein is illustrative rather than limiting and various modifications and additions thereto may occur to persons skilled in the art. Medium or high density polyethylene is a good choice for the injection molding of the caddy 10, but other plastics such as polyurethane and/or the more expensive elastomeric plastics can also be used. Color is a matter of choice and a place may be provided to receive a sticker or label with the student's name if desired.

What is claimed is:

1. A student's desk caddy comprising:
integral front, back and opposite side walls and a floor extending fully between said front back and opposite side walls to define a rectangular box with an open top;
at least one divider extending between the front and back walls parallel to and spaced from a sidewall to define a compartment within the box; each of said front, back and sidewalls having a top edge;
a pattern of raised elements extending over the floor in said compartment such that a bottle or similar object placed in said compartment is in spaced relationship to said floor; and
means for attaching the caddy to a desk.

2. A desk caddy as defined in claim 1 wherein the front wall is sloped from said divider to one of said side walls such that the sidewall defining said compartment is higher than the opposite side wall.

3. A desk caddy as defined in claim 1 further including a second divider extending between the front and back walls in parallel spaced relationship to the first divider and defining second and third compartments.

4. A desk caddy as defined in claim 1 wherein the attachment means comprises a hanger integral with the back wall.

5. A desk caddy as defined in claim 4 wherein the back wall is non-planar and is bumped out toward the bottom, the at least one hanger terminating short of the bumped out back portion.

6. A desk caddy as defined in claim 1 wherein the attachment means comprises a pair of spaced apart flanges attached to the back wall and adapted to slide onto the edge of a desk top.

7. A desk caddy as defined in claim 6 wherein the attachment means is attached to the back wall by a hinge.

8. A desk caddy as defined in claim 1 wherein the material of construction is plastic.
